(19) United States
(12) Patent Application Publication
(10) Pub. No.: US 2015/0234227 A1
(43) Pub. Date: Aug. 20, 2015

(54) LIQUID CRYSTAL DISPLAY AND METHOD OF MANUFACTURING THE SAME

(71) Applicant: Samsung Display Co., Ltd., Yongin-City (KR)

(72) Inventors: Seok-Joon HONG, Seongnam-si (KR); Seon Uk LEE, Seongnam-si (KR); Tae Woo LIM, Hwaseong-si (KR)

(21) Appl. No.: 14/456,247

(22) Filed: Aug. 11, 2014

(30) Foreign Application Priority Data
Feb. 17, 2014 (KR) 10-2014-0018048

(51) Int. Cl. G02F 1/1333; G02F 1/1362; G02F 1/1341; G02F 1/1368

(52) U.S. Cl. CPC G02F 1/133345; G02F 1/1368; G02F 1/136286; G02F 1/133305; G02F 1/133377; G02F 1/1341; G02F 2001/136295

(57) ABSTRACT

A liquid crystal display includes: a substrate; a thin film transistor; a pixel electrode; an insulating layer; a plurality of microcavities; and a partition. The thin film transistor is disposed on the substrate. The pixel electrode is connected to the thin film transistor. The insulating layer is disposed to face the pixel electrode. The microcavities are between the pixel electrode and the insulating layer, wherein the microcavities include a liquid crystal material. The partition is between the microcavities, wherein the partition has a bar shape and is disposed on the insulating layer.

### CROSS-REFERENCE TO RELATED APPLICATION

This application claims priority to and the benefit of Korean Patent Application No. 10-2014-0018048 filed in the Korean Intellectual Property Office on Feb. 17, 2014, the entire contents of which are incorporated herein by reference.

### BACKGROUND

(a) Field

The present application relates to a liquid crystal display and a manufacturing method thereof.

(b) Description of the Related Art

A liquid crystal display panel, which is one of the more common types of flat panel displays currently in use, includes two sheets of substrates with field generating electrodes such as a pixel electrode and a common electrode, and a liquid crystal layer interposed therebetween.

The liquid crystal display generates electric fields in the liquid crystal layer by applying voltages to the field generating electrodes, determines the alignment of liquid crystal molecules of the liquid crystal layer by the generated electric field, and controls polarization of incident light, thereby displaying images.

A technique of forming a cavity in a pixel and filling the cavity with liquid crystals to implement a display has been developed for one of the liquid crystal displays. Although two sheets of substrates are used in a conventional liquid crystal display, this technique forms constituent elements on one substrate, thereby reducing weight, thickness, and the like of the device.

In the display device including a plurality of microcavities, a roof layer to maintain the microcavities is formed. The roof layer may he continuously connected between adjacent microcavities. The roof layer may be formed of a composite layer of an inorganic layer and an organic layer.

Like this, when the roof layer is formed of the composite layer of the inorganic layer and the organic layer, a process time is increased due to an increase of a number of masks. Also, since it is necessary to increase an alignment margin by considering a misalignment between the organic layer and the inorganic layer, the aperture ratio may be deteriorated.

The above information disclosed in this Background section is only for enhancement of understanding of the background and therefore it may contain information that does not form the prior art that is already known in this country to a person of ordinary skill in the art.

### SUMMARY

Embodiments provide a liquid crystal display in which a process time is reduced and an aperture ratio is improved, and a manufacturing method thereof.

A liquid crystal display according to an exemplary embodiment includes: a substrate; a thin film transistor; a pixel electrode; an insulating layer; a plurality of microcavities; and a partition. The thin film transistor is disposed on the substrate. The pixel electrode is connected to the thin film transistor. The insulating layer is disposed to face the pixel electrode. The microcavities are between the pixel electrode and the insulating layer, wherein the microcavities include a liquid crystal material. The partition is between the microcavities, wherein the partition has a bar shape and is disposed on the insulating layer.

The partition may include an organic material.

The insulating layer may be an inorganic insulating layer.

The insulating layer may be disposed at an entire area on the substrate.

A capping layer disposed on the insulating layer may be further included, and the capping layer may contact an upper surface of the insulating layer.

A liquid crystal injection hole formation region may be between the microcavities, and the capping layer may be disposed at the liquid crystal injection hole formation region.

A common electrode disposed between the microcavities and the insulating layer may be further included, and a side surface of the common electrode and a side surface of the insulating layer may be engaged at the liquid crystal injection hole formation region.

A data line connected to the thin film transistor may be further included, and the partition may extend in a direction parallel to the data line.

The partition may be disconnected according to the direction of the data line.

A gate line disposed on the substrate and crossing the data line may be further included, and the partition may not cross the gate line.

A manufacturing method of a liquid crystal display according to an exemplary embodiment includes the following. A thin film transistor is formed on a substrate.

A pixel electrode connected to one terminal of the thin film transistor is formed. A sacrificial layer is formed on the pixel electrode. An insulating layer is formed on the sacrificial laver. An organic layer is formed on the insulating layer, and the insulating layer is patterned by using the organic layer as a mask. The sacrificial layer is removed to form a plurality of microcavities. The organic layer is patterned. A liquid crystal material is injected to the microcavities, wherein the patterning of the organic layer includes removing the organic layer disposed at a portion corresponding to the microcavities and forming a partition between the microcavities.

The partition may be formed on the insulating layer. The forming of the sacrificial layer may include forming an opening at a portion overlapping a data line connected to the thin film transistor.

The insulating layer formed on the sacrificial layer may extend and may be formed along the opening.

The partition may be formed along a direction that the opening extends.

The insulating layer may be an inorganic insulating layer.

The insulating layer may be formed at an entire area on the substrate.

The method may further include forming a capping layer on the insulating layer, and the capping layer may contact an upper surface of the insulating layer.

The method may further include forming a liquid crystal injection hole formation region between the microcavities, and the capping layer may be formed to be disposed at the liquid crystal injection hole formation region.

The method may further include forming a common electrode between the microcavities and the insulating layer, and a side surface of the common electrode and a side surface of the insulating layer may be formed to be engaged at the liquid crystal injection hole formation region.

According to an exemplary embodiment, an additional inorganic insulating layer may be omitted on the roof layer including the organic material such that a number of masks may be reduced.

Also, transmittance and an aperture ratio may be improved by simplifying a structure of the roof layer.

Further, in the manufacturing process, the organic layer is coated on the inorganic insulating layer such that damage to the inorganic layer may be prevented.

### BRIEF DESCRIPTION OF THE DRAWINGS

FIG. 1 is a top plan view of a liquid crystal display according to an exemplary embodiment.

FIG. 2 is a cross-sectional view taken along a line II-II of FIG. 1.

FIG. 3 is a cross-sectional view taken along a line III-III of FIG. 1.

FIG. 4 is a schematic top plan view of a region where a partition is formed in the exemplary embodiment of FIG. 1 to FIG. 3.

FIGS. 5, 6, 7, 8, 9, 10, 11, 12, 13, 14, 15, 16, 17 are cross-sectional views showing a manufacturing method of a liquid crystal display according to an exemplary embodiment.

### DETAILED DESCRIPTION OF THE EMBODIMENTS

Exemplary embodiments will be described in detail with reference to the attached drawings. The embodiments may be modified in many different forms and should not be construed as being limited to the exemplary embodiments set forth herein. Rather, the exemplary embodiments are provided so that this disclosure will be thorough and complete, and will fully convey the concept of the inventive concept to those skilled in the art.

In the drawings, the thickness of layers and regions may be exaggerated for clarity. In addition, when a layer is described to be formed on another layer or on a substrate, this means that the layer may be formed on the other layer or on the substrate, or a third layer may be interposed between the layer and the other layer or the substrate. Like numbers refer to like elements throughout the specification.

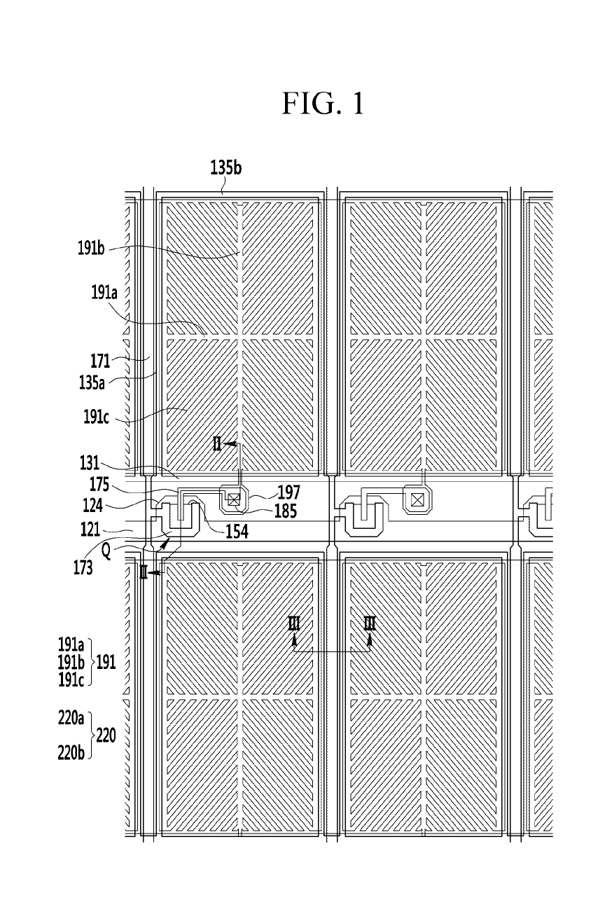

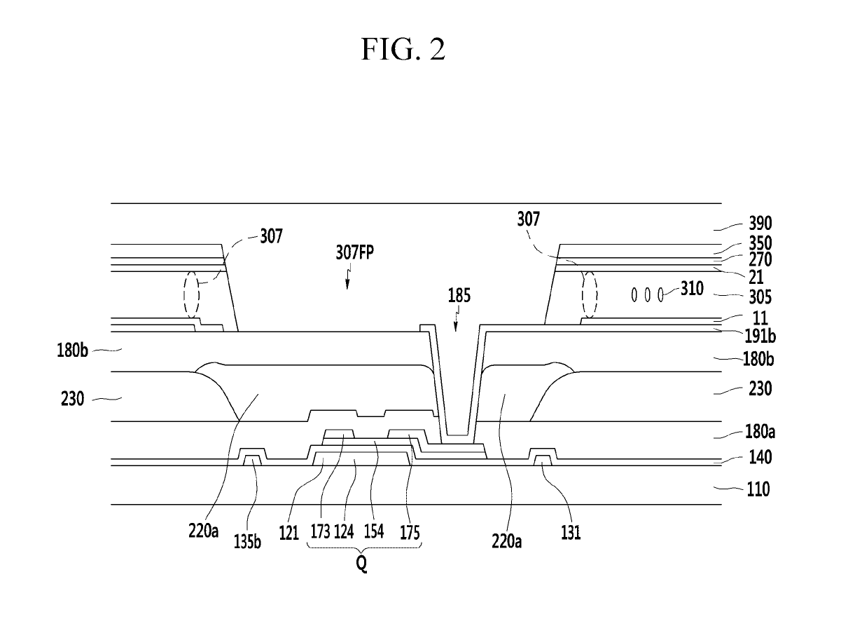

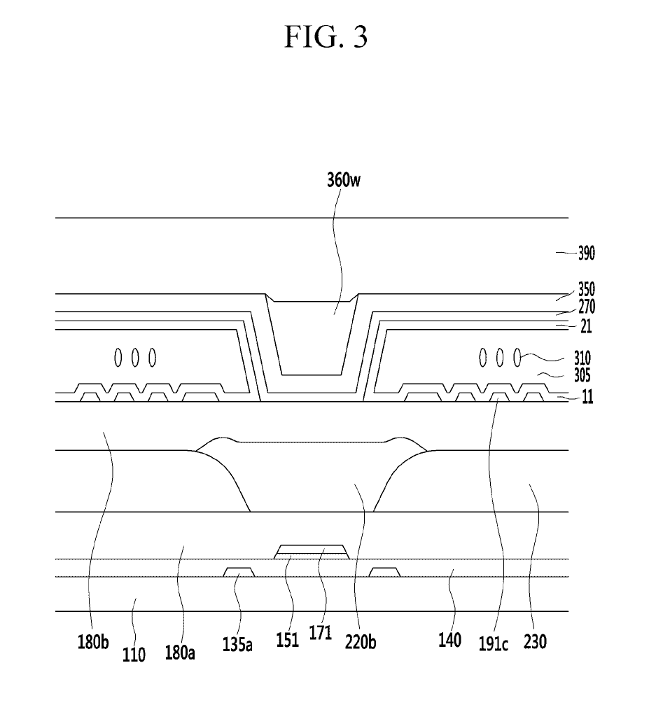

FIG. 1 is a top plan view of a liquid crystal display according to an exemplary embodiment. FIG. 2 is a cross-sectional view taken along a line II-II of FIG. 1. FIG. 3 is a cross-sectional view taken along a line III-III of FIG. 1.

FIG. 1 shows a 2*2 pixel portion as a center portion of a plurality of pixels, and these pixels may be repeatedly arranged up/down and right/left in the liquid crystal display according to an exemplary embodiment.

Referring to FIG. 1 to FIG. 3, a gate line 121 and a storage electrode line 131 are formed on a substrate 110 made of transparent glass or plastic. The gate line 121 includes a gate electrode 124. The storage electrode line 131 is mainly extended in a horizontal direction, and transfers a predetermined voltage such as a common voltage Vcom. The storage electrode line 131 includes a pair of vertical storage electrode portions 135a substantially extended to be perpendicular to the gate line 121, and a horizontal storage electrode portion 135b connecting ends of the pair of vertical storage electrode portions 135a to each other. The storage electrode portions 135a and 135b have a structure surrounding a pixel electrode 191.

A gate insulating layer 140 is formed on the gate line 121 and the storage electrode line 131. A linear semiconductor layer 151 disposed under a data line 171 and a semiconductor layer 154 under a source/ drain electrode and corresponding to a channel region of a thin film transistor Q are formed on the gate insulating layer 140. The linear semiconductor layer 151 and the semiconductor layer 154 under the source/drain electrode and corresponding to the channel region of the thin film transistor Q may be connected to each other.

A plurality of ohmic contacts may be formed between the linear semiconductor layer 151 and the data line 171, and between the semiconductor layer 154 under the source/drain electrode and corresponding to the channel region and the source/drain electrode, and are omitted in the drawings.

Data conductors 171, 173, and 175 including a source electrode 173, the data line 171 connected to the source electrode 173, and a drain electrode 175 are formed on the semiconductor layers 151 and 154 and the gate insulating layer 140.

The gate electrode 124, the source electrode 173, and the drain electrode 175 form the thin film transistor Q along with the semiconductor layer 154, and the channel of the thin film transistor Q is formed in the exposed portion of the semiconductor layer between the source electrode 173 and the drain electrode 175.

A first interlayer insulating layer 180a is formed on the data conductors 171, 173, and 175 and the exposed semiconductor layer. The first interlayer insulating layer 180a may include an inorganic insulator such as a silicon nitride (SiNx) and a silicon oxide (SiOx), or an organic insulator.

A color filter 230 and a light blocking member 220 are formed on the first interlayer insulating layer 180a.

The light blocking member 220 has a lattice structure having an opening corresponding to a region displaying an image, and is formed of a material that prevents light from being transmitted therethrough. The color filter 230 is formed at the opening of the light blocking member 220. The light blocking member 220 includes a horizontal light blocking member 220a formed in a direction parallel to the gate line 121, and a vertical light blocking member 220h formed in a direction parallel to the data line 171.

The color filter 230 may display one of primary colors, such as three primary colors including red, green, and blue. However, the colors are not limited to the three primary colors including red, green, and blue, and the color filter 230 may also display one among a cyan-based color, a magenta-based color, a yellow-based color, and a white-based color. The color filter 230 may be formed of materials displaying different colors for each adjacent pixel.

A second interlayer insulating layer 180b covering the color filter 230 and the light blocking member 220 is formed on the color filter 230 and the light blocking member 220. The second interlayer insulating layer 180h may include the inorganic insulating material such as a silicon nitride (SiNx) and a silicon oxide (SiOx), or the organic insulating material. Unlike the cross-sectional view of FIG. 2, in a case where a step is generated due to a difference in thickness between the color filter 230 and the light blocking member 220, the second interlayer insulating layer 180b includes an organic insulating material, so that it is possible to decrease or remove the step.

The color filter 230, the light blocking member 220, and the interlayer insulating layers 180a and 180h have a contact hole 185 extending to and exposing the drain electrode 175.

The pixel electrode 191 is formed on the second interlayer insulating layer 180b. The pixel electrode 191 may be made of a transparent conductive material such as ITO or IZO.

An overall shape of the pixel electrode 191 is a quadrangle, and the pixel electrode 191 includes cross stems configured by a horizontal stem 191a and a vertical stem 191b crossing the horizontal stem 191a. Further, the pixel electrode 191 is divided into four sub-regions by the horizontal stem 191a and the vertical stem 191b, and each sub-region includes a plurality of minute branches 191c. In the present exemplary embodiment, the pixel electrode 191 may further include an outer stem surrounding an outer circumference of the pixel electrode 191.

The minute branches 191c of the pixel electrode 191 form an angle of approximately 40° to 45° with the gate line 121 or the horizontal stem 191a. Further, the minute branches 191c of two adjacent sub-regions may be perpendicular to each other. Furthermore, a width of each minute branch 191c may be gradually increased, or a distance between the minute branches 191c may be varied.

The pixel electrode 191 includes an extension 197 which is connected at a lower end of the vertical stem 191b and has a larger area than the vertical stem 191b. The extension 197 of the pixel electrode 191 is physically and electrically connected to the drain electrode 175 through the contact hole 185, thereby receiving a data voltage from the drain electrode 175.

The thin film transistor Q and the pixel electrode 191 described above are just described as examples, and a structure of the thin film transistor and a design of the pixel electrode may be modified in order to improve side visibility.

A lower alignment layer 11 is formed on the pixel electrode 191, and may be a vertical alignment laver. The lower alignment layer 11, as a liquid crystal alignment layer made of a material such as polyamic acid, polysiloxane, polyimide, or the like, may include at least one of generally used materials. Also, the lower alignment layer 11 may be a photoalignment layer.

An upper alignment layer 21 is provided at a portion facing the lower alignment layer 11, and a microcavity 305 is formed between the lower alignment layer 11 and the upper alignment layer 21. A liquid crystal material including liquid crystal molecules 310 is injected into the microcavity 305 through a liquid crystal injection hole 307. In the present exemplary embodiment, the alignment material forming the alignment layers 11 and 21 and the liquid crystal material including the liquid crystal molecules 310 may be injected into the microcavity 305 by using capillary force. The microcavities 305 are divided in the vertical direction by a plurality of liquid crystal injection hole formation regions 307FP disposed at a portion overlapping the gate line 121, thereby forming the plurality of microcavities 305. The plurality of microcavities 305 may he formed along a column direction of the pixel electrode 191, that is, in the vertical direction. Also, the microcavities 305 are divided in the horizontal direction by a partition 360w that will be described later, thereby forming the plurality of microcavities 305. The plurality of microcavities 305 may he formed along the row direction of the pixel electrode 191, in other words, the horizontal direction in which the gate line 121 extends. The plurality of formed microcavities 305 may respectively correspond to the pixel area, and the pixel areas may correspond to a region displaying the image.

The liquid crystal injection hole formation region 307FP may be elongated according to the extending direction of the gate line 121. The liquid crystal injection hole formation region 307FP may horizontally divide the microcavities 305, and may he an empty space where a common electrode 270 and an insulating layer 350 are removed. The liquid crystal injection hole formation region 307FP may he covered by a capping layer 390 after injecting a liquid crystal material including the alignment layers 11 and 21 and the liquid crystal molecules 310 into the microcavities 305.

The liquid crystal injection hole formation region 307FP may be a path where the alignment material or the liquid crystal material are filled in and the alignment material or the liquid crystal material are injected into the microcavity 305 through the liquid crystal injection hole 307.

The common electrode 270 and the insulating layer 350 are disposed on the upper alignment layer 21. The common electrode 270 receives the common voltage, and generates an electric field together with the pixel electrode 191 to which the data voltage is applied to determine a direction in which the liquid crystal molecules 310 disposed at the microcavity 305 between the two electrodes are inclined. The common electrode 270 may be made of the transparent conductive material such as ITO or IZO. The common electrode 270 forms a capacitor with the pixel electrode 191 to maintain the received voltage even after the thin film transistor Q is turned off. The insulating layer 350 may be the inorganic insulating layer formed of the inorganic material such as a silicon nitride (SiNx) or a silicon oxide (SiOₓ). Although not shown, the insulating layer 350 may be formed by depositing two more inorganic layers.

In the present exemplary embodiment, the insulating layer 350 may have a function of the roof layer of the microcavity 305 so as to not change a shape thereof. The insulating layer 350 as the roof layer may have a function of supporting the structure of the microcavity 305 such that the microcavity 305 that is the space between the pixel electrode 191 and the common electrode 270 may maintain the shape thereof.

To support the structure of the microcavity 305, in the present exemplary embodiment, the insulating layer 350 may he formed with a thickness of more than about 4000 angstroms, and preferably, more than 4000 angstroms to less than 10,000 angstroms.

In the present exemplary embodiment, the insulating layer 350 may be disposed on the whole area of the substrate 110 except for the portion of the insulating layer 350 that is removed in the liquid crystal injection hole formation region 307FP.

In the present exemplary embodiment, sides of the common electrode 270 and the insulating layer 350 may be respectively exposed in the liquid crystal injection hole formation region 307FP, and the side surfaces are disposed to be engaged with each other. In other words, the side surface edge of the common electrode 270 and the side surface edge of the insulating layer 350 are aligned.

In the present exemplary embodiment, it is described that the common electrode 270 is formed on the microcavity 305, but in another exemplary embodiment, the common electrode 270 is formed under the microcavity 305, so that liquid crystal driving according to a coplanar electrode (CE) mode is possible.

Referring to FIG. 2, the capping layer 390 is formed on the insulating layer 350. The capping layer 390 includes the organic material or the inorganic material. In detail, the capping layer 390 may be formed of a thermal hardening resin, silicon oxycarbide (SiOC), or graphene. In the present exemplary embodiment, the capping layer 390 may contact the upper surface of the insulating layer 350. The capping layer 390 may be disposed at the liquid crystal injection hole formation region 307FP as well as at the insulating layer 350. At this time, the liquid crystal injection hole 307 of the microcavity 305 exposed by the liquid crystal injection hole formation region 307FP may be covered by the capping layer 390. In the present exemplary embodiment, the liquid crystal material is removed in the liquid crystal injection hole formation region 307FP. But, in a modified exemplary embodiment, the liquid crystal material may remain at the liquid crystal injection hole formation region 307FP after being injected to the microcavity 305.

In the present exemplary embodiment, the partition 360w is formed between the microcavities 305 adjacent in the horizontal direction, as shown in FIG. 3. The partition 360w may extend according to the direction parallel to the data line 171 and may be covered by the capping layer 390. In the present exemplary embodiment, the upper surface of the partition 360w may contact the capping layer 390. The partition 360w may include a photoresist or other organic materials. The partition 360w can partition or define the microcavities 305 according to the horizontal direction. In the present exemplary embodiment, the partition 360w is formed between the microcavities 305 such that generated stress is reduced even if the substrate 110 is bent, and a change degree of a cell gap may be remarkably reduced.

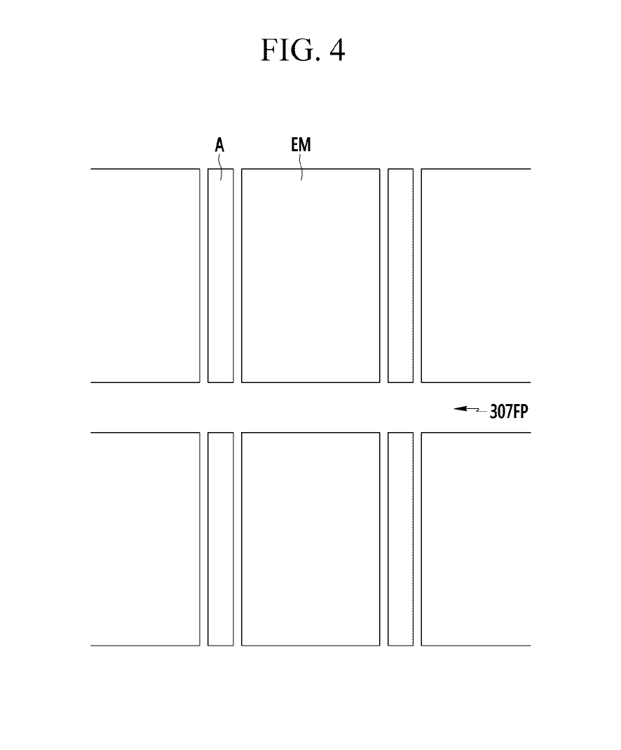

Next, a region where the partition 360w is formed will be described with reference to FIG. 4. FIG. 4 is a schematic top plan view of a region where a partition is formed in the exemplary embodiment of FIG. 1 to FIG. 3. FIG. 4 schematically shows a portion corresponding to the top plan view of FIG. 1.

Referring to FIG. 4, a first region EM corresponding to the plane region of the microcavity 305 corresponding to the pixel electrode 191 and a second region A where the partition 360w is formed between the first regions EM are disposed. Referring to FIG. 1 and FIG. 4, the second region A has a bar shape while overlapping the data line 171 and is disconnected at the liquid crystal injection hole formation region 307FP. In other words, the partition 360w may be disconnectedly formed according to the direction of the data line 171. The liquid crystal injection hole formation region 307FP is a space that is elongated according to the extending direction of the gate line 121 while overlapping the gate line 121 such that the partition 360w may not exist at a portion where the gate line 121 and the data line 171 are crossed. The partition 360w may not cross the gate line 121.

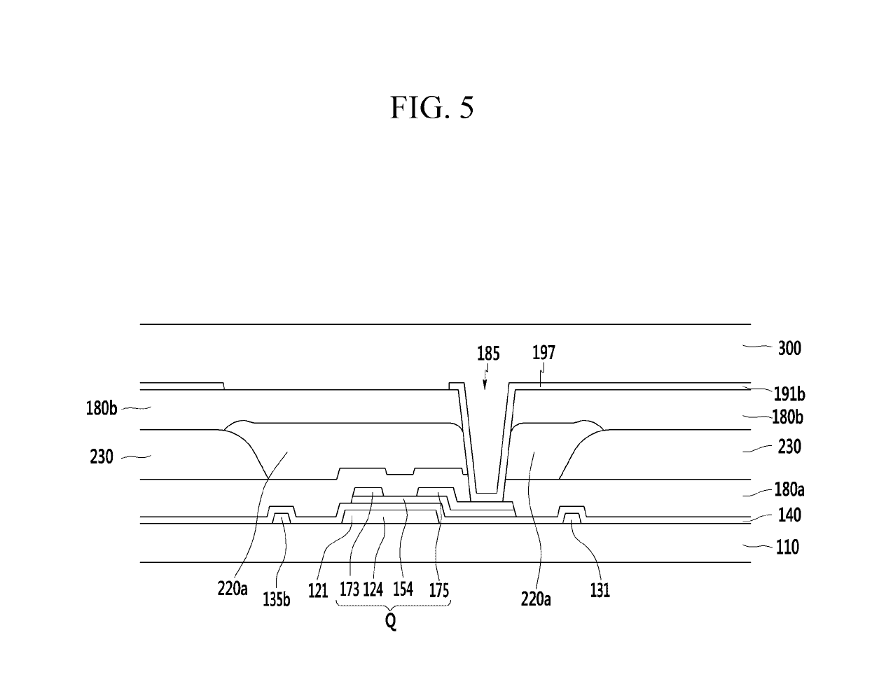

Next, an exemplary embodiment of a method manufacturing the described liquid crystal display will be described with reference to FIG. 5 to FIG. 17. An exemplary embodiment to be described below is an exemplary embodiment of the manufacturing method and may be modified in another form.

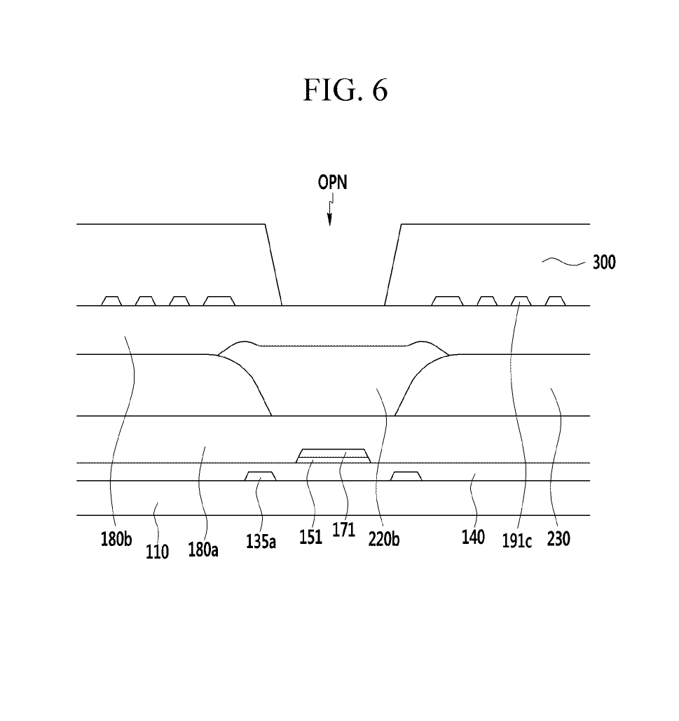

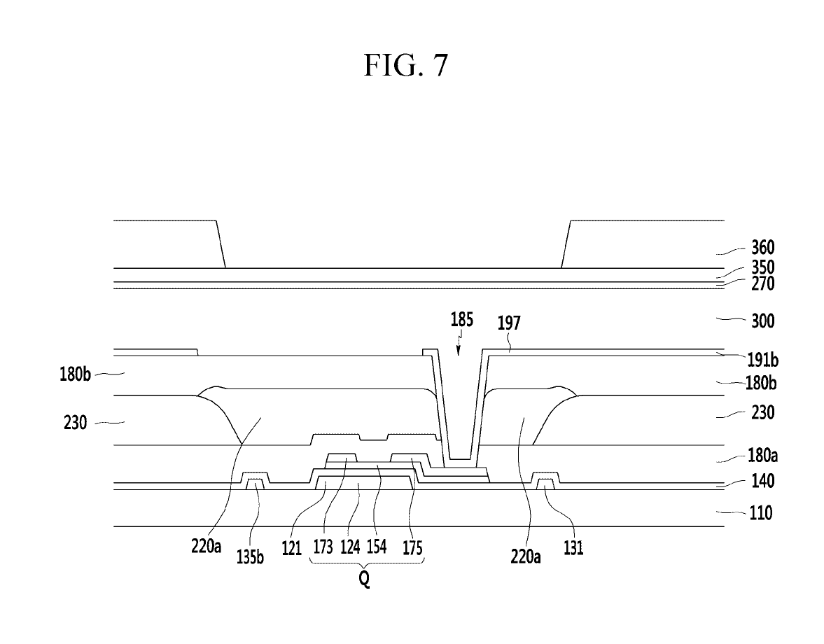

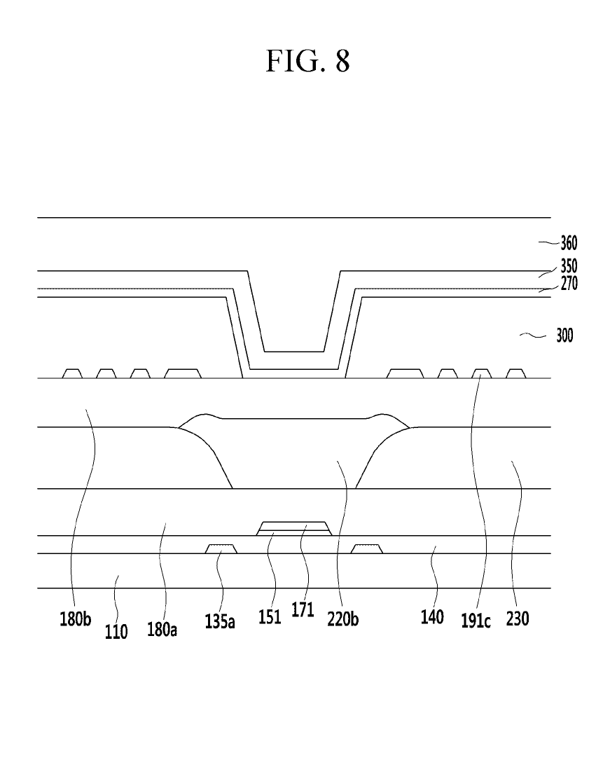

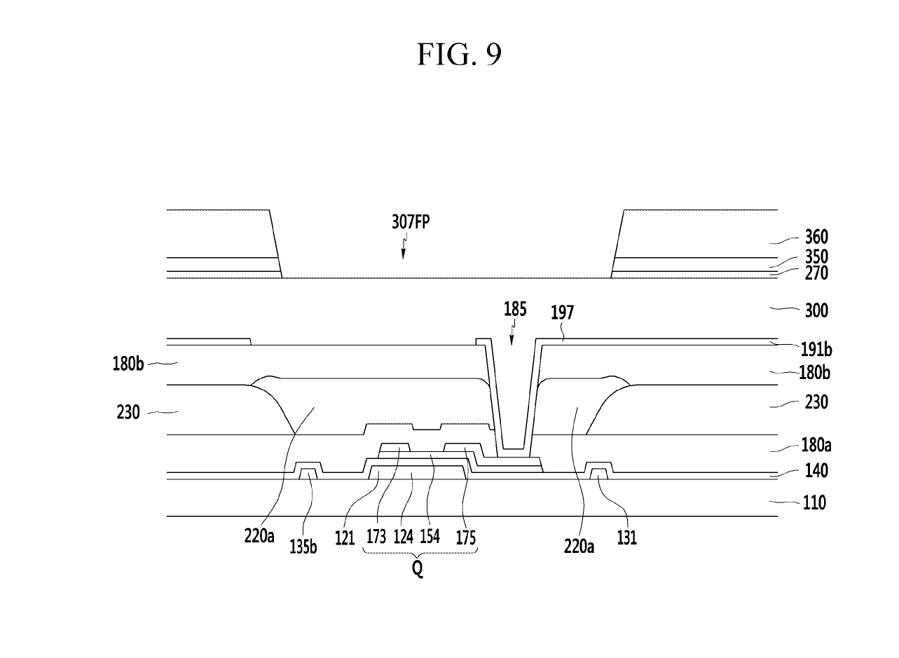

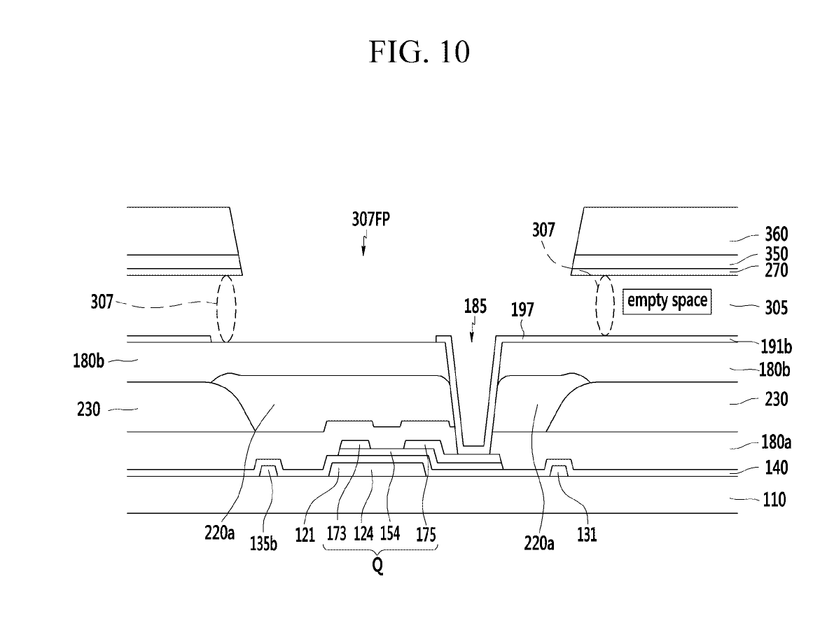

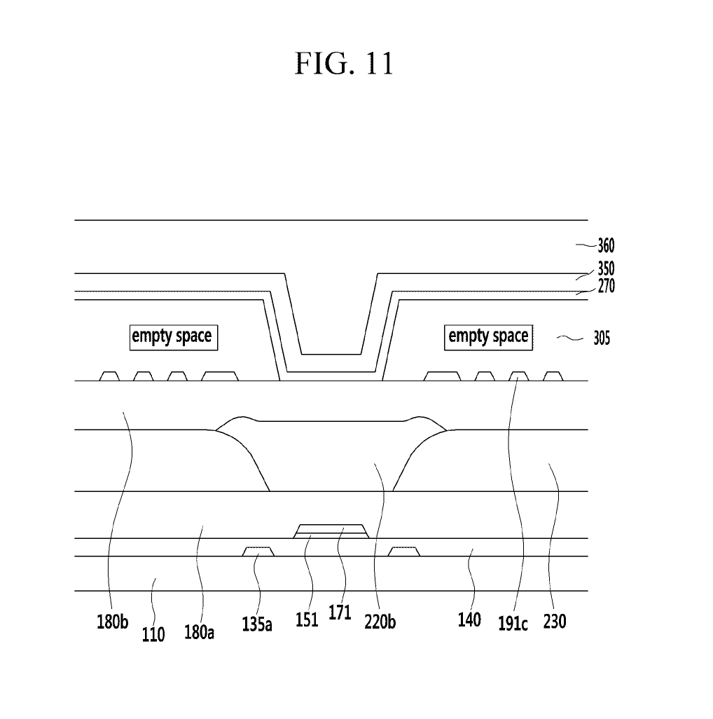

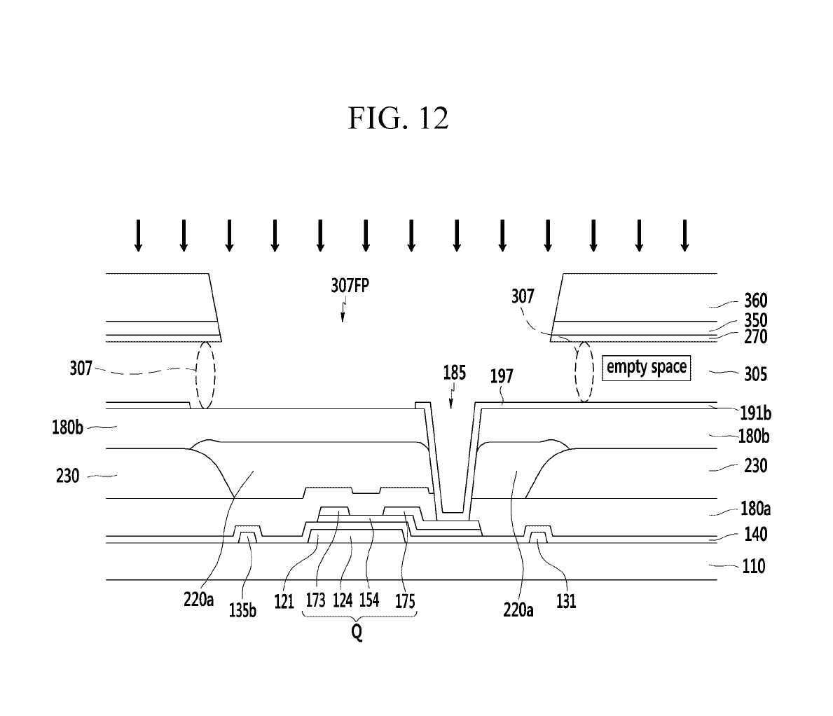

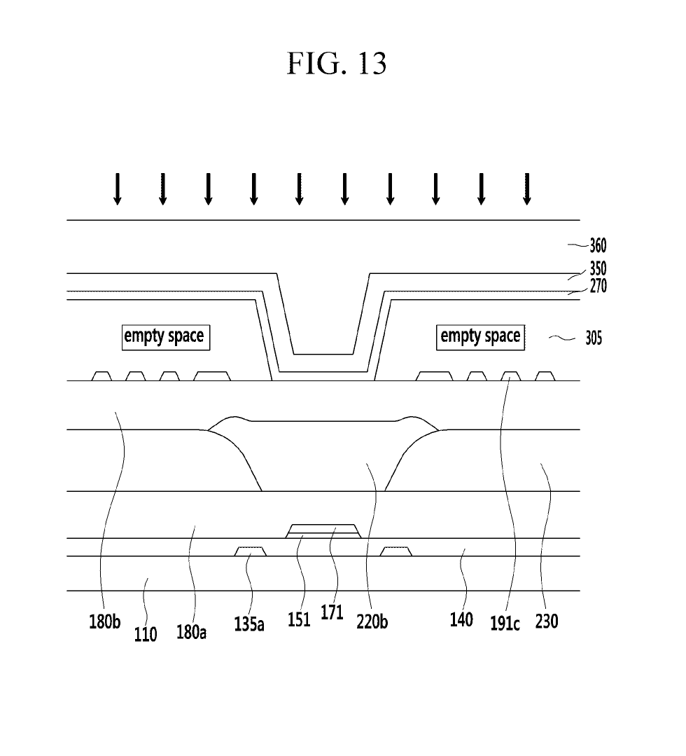

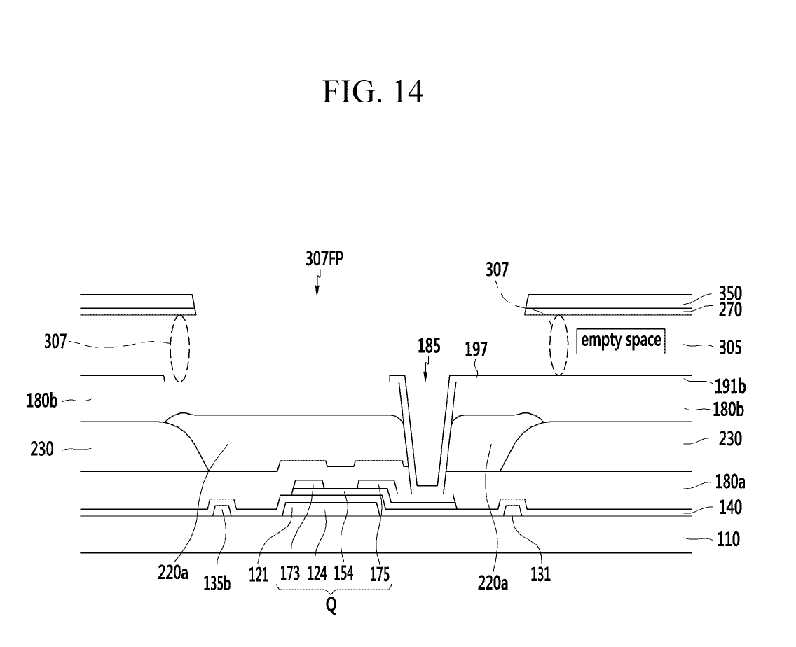

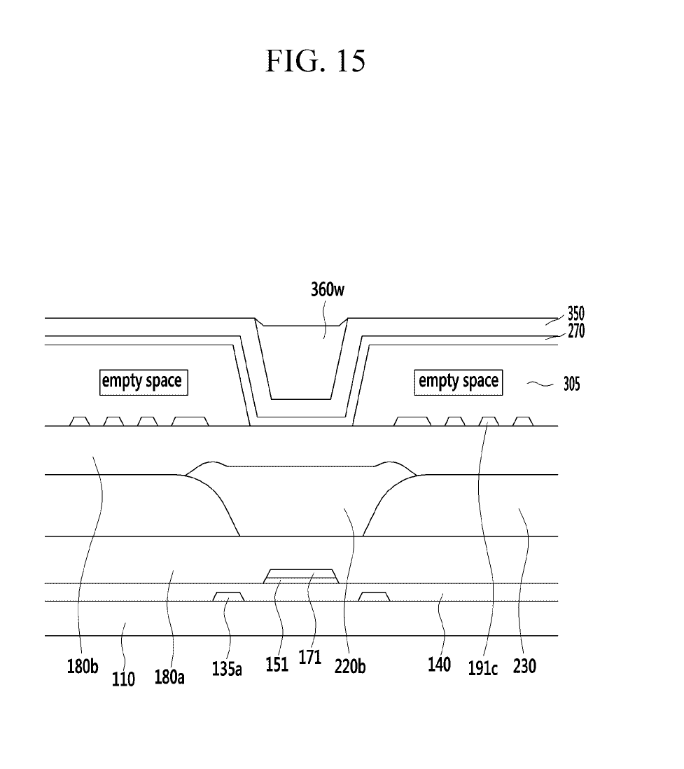

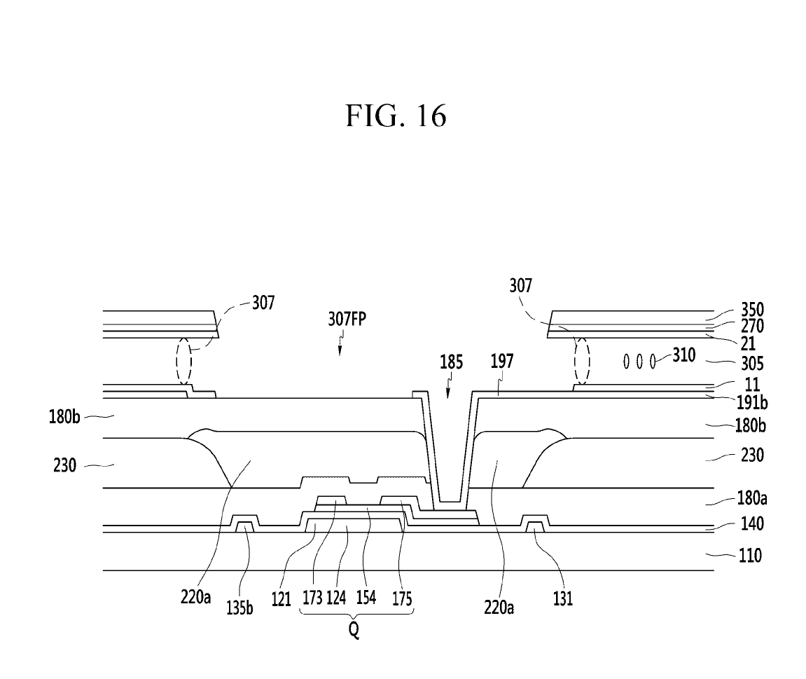

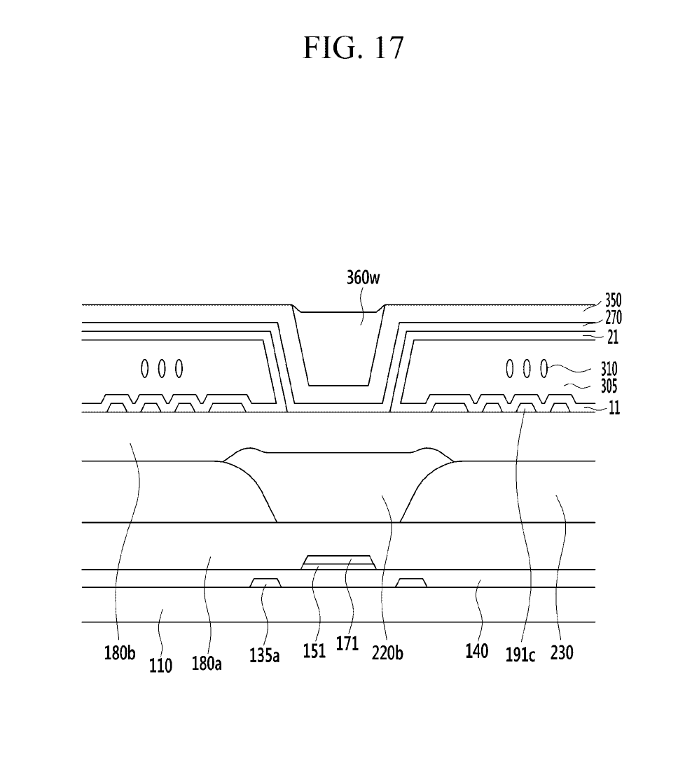

FIG. 5 to FIG. 17 are cross-sectional views showing a manufacturing method of a liquid crystal display according to an exemplary embodiment. FIG. 5, FIG. 7, FIG. 9, FIG. 10, FIG. 12, FIG. 14, and FIG. 16 sequentially show the cross-sectional views taken along the line II-II of FIG. 1. FIG. 6, FIG. 8, FIG. 11, FIG. 13, FIG. 15, and FIG. 17 show the cross-sectional views taken along the line III-III of FIG. 1.

Referring to FIG. 1, FIG. 5, and FIG. 6, to form a generally known switching element on a substrate 110, a gate line 121 extending in a horizontal direction and a gate insulating layer 140 on the gate line 121 are formed, semiconductor layers 151 and 154 are formed on the gate insulating layer 140, and a source electrode 173 and a drain electrode 175 are formed. At this time, the data line 171 connected to the source electrode 173 may be formed to extend in a vertical direction while crossing the gate line 121.

The first interlayer insulating layer 180a is formed on the data conductors 171, 173, and 175 including the source electrode 173, the drain electrode 175, and the data line 171, and the exposed portion of the semiconductor layer 154.

The color filter 230 is formed at a position corresponding to the pixel area on the first interlayer insulating layer 180a, and the light blocking members 220 are formed between the color filters 230. The light blocking member 220 includes a horizontal light blocking member 220a formed in a direction parallel to the gate line 121, and a vertical light blocking member 220b formed in a direction parallel to the data line 171.

The second interlayer insulating layer 180b covering the color filter 230 and the light blocking member 220 is formed on the color filter 230 and the light blocking member 220. The second interlayer insulating layer 180b is formed to have the contact hole 185 for electrically and physically connecting the pixel electrode 191 and the drain electrode 175.

Next, the pixel electrode 191 is formed on the second interlayer insulating layer 180b, and a sacrificial layer 300 is formed on the pixel electrode 191. As shown in FIG. 6, an opening OPN is formed in the sacrificial layer 300 on the data line 171. The opening OPN may be formed with a shape elongated along the direction of the data line 171.

In a subsequent process, the common electrode 270, the insulating layer 350, and an organic layer 360 are filled in the open portion OPN, and the organic layer 360 is patterned to form the partition 360w. The common electrode 270 may be made of a transparent conductive material such as ITO or IZO. The insulating layer 350 may he an inorganic insulating layer formed of an inorganic material such as a silicon nitride (SiNx) or a silicon oxide (SiOₓ).

Referring to FIG. 1, FIG. 7, and FIG. 8, the common electrode 270, the insulating layer 350, and the organic layer 360 are sequentially formed on the sacrificial layer 300. The insulating layer 350 may he an inorganic insulating layer formed of an inorganic material such as a silicon nitride (SiNx) or a silicon oxide (SiOₓ). The organic layer 360 may be a photoresist. In the present exemplary embodiment, the organic layer 360 may be formed with a thickness of less than 2 μm.

The organic layer 360 may he removed in a region corresponding to the horizontal light blocking member 220a disposed between the adjacent pixel areas in the vertical direction through exposing and developing processes. The organic layer 360 exposes the insulating layer 350 to the outside in the region corresponding to the horizontal light blocking member 220a. At this time, the common electrode 270, the insulating layer 350, and the organic layer 360 may fill the opening OPN above the transverse light blocking member 220b.

Referring to FIG. 9, the insulating layer 350 and the common electrode 270 may he patterned by using the organic layer 360 as a mask. The insulating layer 350 and the common electrode 270 may be etched by a dry etching method. By partially removing the insulating layer 350 and the common electrode 270, a liquid crystal injection hole formation region 307FP is formed.

Referring to FIG. 1, FIG. 10, and FIG. 11, the sacrificial layer 300 is removed through the liquid crystal injection hole formation region 307FP by oxygen (O2) ashing treatment or a wet etching method. At this time, the microcavity 305 having the liquid crystal injection hole 307 is formed. The microcavity 305 is an empty space formed when the sacrificial layer 300 is removed.

Referring to FIG. 1, FIG. 12, and FIG. 13, after the sacrificial layer 300 is removed, an ashing treatment may be performed. At this time, an oxygen (O2) ashing treatment may he performed. This may he a process to prevent the liquid crystal display from not being operated by interference with the liquid crystal alignment when the sacrificial layer 300 is not previously completely removed and partially remains. In the present exemplary embodiment, the organic layer 360 may be selectively removed in the ashing treatment. To selectively remove the organic layer 360 on the microcavity 305, the organic layer 360 may be coated with the thickness of less than 2 μm in the process of forming the organic layer 360. However, to control the thickness of the removed organic layer 360, a time of the ashing, treatment may be controlled regardless of the coating thickness.

Referring to FIG. 1, FIG. 14, and FIG. 15, the organic layer 360 on the microcavity 305 may be selectively removed by the ashing treatment. In the present exemplary embodiment, as shown in FIG. 15, the partition 360w is formed between the microcavities 305 adjacent in the direction that the gate lines 121 are extended. In the present exemplary embodiment, the organic layer 360 is selectively removed, and only the organic layer 360 remains at the opening OPN formed in FIG. 6 to form the partition 360w.

As described above, according to the present exemplary embodiment, since the organic layer 360 covers the insulating layer 350 including the inorganic material in the process, the insulating layer 350 may be prevented from being damaged. Also, the organic layer 360 is finally removed at the portion of the insulating layer 350 corresponding to the microcavity 305 such that a structural deformation by a stress difference may be prevented between the inorganic layer and the organic layer.

Referring to FIG. 1, FIG. 16, and FIG. 17, an alignment material is injected through the liquid crystal injection hole formation region 307FP and the liquid crystal injection hole 307 to form alignment layers 11 and 21 on the pixel electrode 191 and the common electrode 270. In detail, a bake process is performed after injecting an alignment material including a solid content and a solvent through the liquid crystal injection hole 307.

Next, a liquid crystal material including the liquid crystal molecules 310 is injected into the microcavity 305 via the liquid crystal injection hole 307, using an inkjet method and the like.

Thereafter, the capping layer 390 is formed on the insulating layer 350 to cover the liquid crystal injection hole 307 and the liquid crystal injection hole formation region 307FP to form the liquid crystal display illustrated in FIGS. 2 and 3.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

<Description of Symbols>

| | | | |
|---|---|---|---|
| 300 | sacrificial layer | 305 | microcavity |
| 307 | liquid crystal injection hole | 350 | insulating layer |
| 360 | organic layer | 360w | partition |
| 390 | capping layer | | |

What is claimed is:

1. A liquid crystal display comprising:
a substrate;
a thin film transistor disposed on the substrate;
a pixel electrode connected to the thin film transistor;
an insulating layer disposed to face the pixel electrode;
a plurality of microcavities between the pixel electrode and the insulating layer, wherein the microcavities include a liquid crystal material; and
a partition between the microcavities,
wherein the partition has a bar shape and is disposed on the insulating layer.

2. The liquid crystal display of claim 1, wherein the partition includes an organic material.

3. The liquid crystal display of claim 2, wherein the insulating layer is an inorganic insulating layer.

4. The liquid crystal display of claim 3, wherein the insulating layer is disposed at an entire area on the substrate.

5. The liquid crystal display of claim 4, further comprising
a capping layer disposed on the insulating layer, and the capping layer contacts an upper surface of the insulating layer.

6. The liquid crystal display of claim 5, wherein
a liquid crystal injection hole formation region is between the microcavities, and the capping layer is disposed at the liquid crystal injection hole formation region.

7. The liquid crystal display of claim 6, further comprising a common electrode disposed between the microcavities and the insulating layer, and a side surface of the common electrode and a side surface of the insulating layer are engaged at the liquid crystal injection hole formation region.

8. The liquid crystal display of claim 2, further comprising
a data line connected to the thin film transistor, and the partition extends in a direction parallel to the data line.

9. The liquid crystal display of claim 8, wherein
the partition is disconnected according to the direction of the data line.

10. The liquid crystal display of claim 9, further comprising
a gate line disposed on the substrate and crossing the data line, and
the partition does not cross the gate line.

11. A method of manufacturing a liquid crystal display, comprising:
forming a thin film transistor on a substrate;
forming a pixel electrode connected to one terminal of the thin film transistor;
forming a sacrificial layer on the pixel electrode;
forming an insulating layer on the sacrificial layer;
forming an organic layer on the insulating layer;
patterning the insulating layer by using the organic layer as a mask;
removing the sacrificial layer to form a plurality of microcavities;
patterning the organic layer; and
injecting a liquid crystal material to the microcavities,
wherein the patterning of the organic layer includes removing the organic layer disposed at a portion corresponding to the microcavities and forming a partition between the microcavities.

12. The method of claim 11, wherein
the partition is formed on the insulating layer.

13. The method of claim 12, wherein
the forming of the sacrificial layer includes forming an opening at a portion overlapping a data line connected to the thin film transistor.

14. The method of claim 13, wherein
the insulating layer formed on the sacrificial layer extends and is formed along the opening.

15. The method of claim 14, wherein
the partition is formed along a direction that the opening extends.

16. The method of claim 11, wherein
the insulating layer is an inorganic insulating layer.

17. The method of claim 12, wherein
the insulating layer is formed at an entire area on the substrate.

18. The method of claim 17, further comprising
forming a capping layer on the insulating layer, and the capping layer contacts an upper surface of the insulating layer.

19. The method of claim 18, further comprising
forming a liquid crystal injection hole formation region between the microcavities, and the capping layer is formed to be disposed at the liquid crystal injection hole formation region.

20. The method of claim 19, further comprising forming a common electrode between the microcavities and the insulating layer, and a side surface of the common electrode and a side surface of the insulating layer are formed to be engaged at the liquid crystal injection hole formation region.
